(19) United States
(12) Patent Application Publication
(10) Pub. No.: US 2013/0162139 A1
(43) Pub. Date: Jun. 27, 2013

(54) LIGHT EMITTING DIODE BULBS WITH HIGH HEAT DISSIPATING EFFICIENCY

(71) Applicant: Foxconn Technology Co., Ltd., New Taipei (TW)

(72) Inventor: TAY-JIAN LIU, New Taipei (TW)

(73) Assignee: FOXCONN TECHNOLOGY CO., LTD., New Taipei (TW)

(21) Appl. No.: 13/710,256

(22) Filed: Dec. 10, 2012

(30) Foreign Application Priority Data
Dec. 22, 2011 (CN) 201110434318.7

(51) Int. Cl. F21V 29/00

(52) U.S. Cl. CPC F21V 29/006
USPC 315/51

(57) ABSTRACT

An exemplary LED bulb includes a top optical section, a middle heat dissipation section, and a bottom electrical section. The optical section includes a light source and a light guider. The light source further includes a substrate and at least one LED arranged on the substrate. The heat dissipation section includes a sleeve at a rear of the optical section and a chamber. The sleeve has a tube portion and a sealed end with a heat absorbing surface thermally contacting the substrate. A porous wick structure is arranged on the outer sidewall of the tube portion and contains working fluid therein. The chamber has an annular configuration defined between an inner side surface of an LED bulb shell and an outer side surface of the sleeve. The electrical section includes a threaded cap arranged at a bottom portion of the LED bulb, and a circuit board received in the sleeve.

### BACKGROUND

1. Technical Field

The present disclosure generally relates to light emitting diode (LED) bulbs, and particularly to an LED bulb with high heat dissipating efficiency.

2. Description of Related Art

Due to that traditional illuminating light sources are energy consuming, LEDs have a potential of being widely used as substitute for traditional illuminating light sources because of high luminous efficiency, energy saving, long lifespan, environmental friendly property, low driving voltage, low temperature luminescence, fast starting, small volume, high directivity, excellent quake proof performance and shock resistance thereof.

However, LEDs employed in illumination devices must be equipped with means with high heat dissipating efficiency to give play to above mentioned advantages. Otherwise, the luminous efficiency and lifespan of LEDs will be heavily discounted, thereby leading to loss of energy saving effect, low reliability, light attenuation and failure of the LEDs. As such, it is very important to realize the heat generation of the LED bulbs, and to use proper heat conductive material in LED bulbs and to sort out scientific heat dissipating solutions.

General LED bulbs transfer heat, via long heat conducting path, to heat sinks with big surface area and successively to ambient cool air. As such, the heat sinks are usually big and heavy, thereby unfavorable for miniaturization design thereof.

Further, due to usual LED bulbs need to be configured with a great temperature gradient along heat conducting path thereof, load diversity of the heat sink will lead to low utilization rate and rise of temperature, and the rise of temperature will undesirably lead to light attenuation of the LEDs. As such, considering about traditional bulb size and receptacle loading, usual LED bulbs are designed with low power and unsatisfied for high power illumination.

Still further, usual LED bulbs mainly focus on dissipating heat from the LED source, ignoring heat dissipation of the circuit boards therein. As such, the circuit boards may be overheated and aged rapidly.

Therefore, it is necessary to provide an LED bulb with high heat dissipating efficiency which can overcome the above shortcomings

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic, cross section view of an LED bulb in accordance with a first embodiment of the present disclosure.

FIG. 2 is a schematic, cross section view of an LED bulb in accordance with a second embodiment of the present disclosure.

FIG. 3 is a schematic, cross section view of an LED bulb in accordance with a third embodiment of the present disclosure.

FIG. 4 is a cross section view of one exemplary sleeve of the LED bulb in accordance with the third embodiment of the present disclosure.

FIG. 5 is a cross section view of one further exemplary sleeve of the LED bulb in accordance with the third embodiment of the present disclosure.

FIG. 6 is a cross section view of another exemplary sleeve of the LED bulb in accordance with the third embodiment of the present disclosure.

FIG. 7 is a schematic, isometric view of an alternative heat spreading plate of the sleeve illustrated in FIG. 5.

FIG. 8 is a schematic, cross section view of an LED bulb in accordance with a fourth embodiment of the present disclosure.

FIG. 9 is a schematic, cross section view of an LED bulb in accordance with a fifth embodiment of the present disclosure.

### DETAILED DESCRIPTION

Reference will now be made to the drawings to describe exemplary embodiments of the present LED bulb with high heat dissipating efficiency.

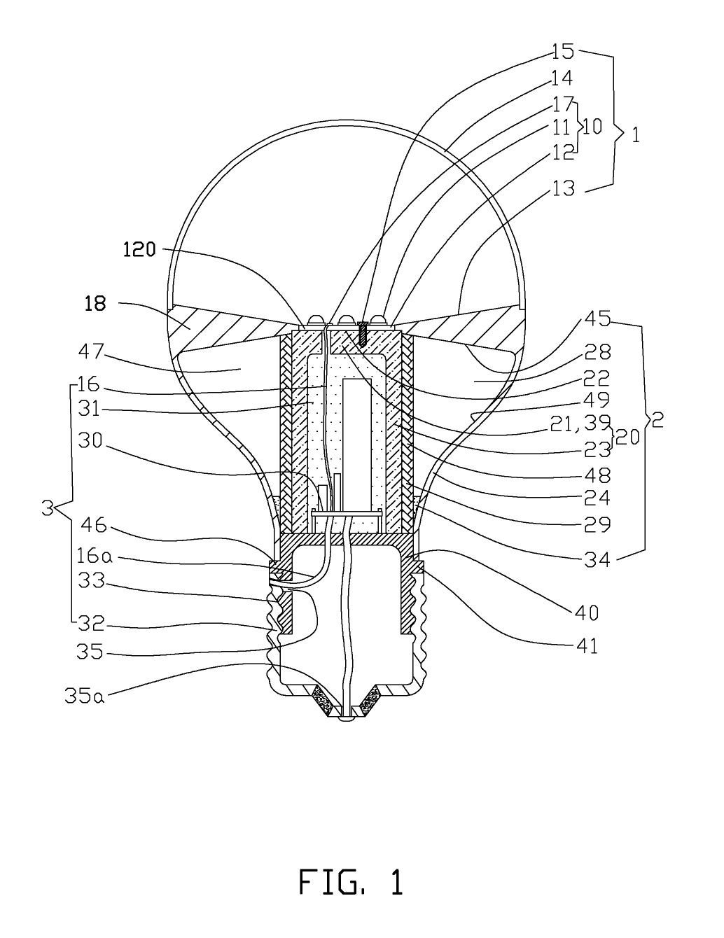

Referring to FIG. 1, an LED bulb in accordance with a first embodiment of the present disclosure, includes an optical section 1 arranged a top portion of the LED bulb, a heat dissipation section 2 arranged a middle portion of the LED bulb, and an electrical section 3.

The optical section 1 is arranged in font of the heat dissipation section 2 and the electrical section 3. The optical section 1 includes a light source 10 having at least one LED 11 and a light guider 14. The light guider 14 is configured for adjusting luminance distribution and light emitting properties of the LED 11, and protecting the light source 10 from ambient environment.

The light source 10 further includes a substrate 12 wherein both the at least one LED 11 and a plurality of electrodes 17 are mounted on and electrically connected to an electrical circuit formed on one side of a heat conductive plate 120 of the substrate 12. The at least one LED 11 is constructed by at least one encapsulated LED die. A thermal contact of the light source 10 and a heat absorbing surface 22 of the heat dissipation section 2 is achieved by following steps: arranging a thermal interface material layer between the other side of the heat conductive plate 120 of the substrate 12 opposite to the at least one LED 11 and the heat absorbing surface 22; fixing the substrate 12 on the heat absorbing surface 22 via a plurality of bolts 15 penetrating through the substrate 12 and embedded in the heat dissipation section 2. The plurality of electrodes 17 of the light source 10 is electrically connected to a circuit board 30 of the electrical section 3 by wires 16, and the circuit board 30 is electrically connected to a threaded cap 32 of the electrical section 3 by wires 16a.

The light guider 14 is a light transmissive cover receiving the light source 10 therein. In this embodiment, the light guider 14 is configured as a globular cover of traditional incandescence bulbs, adjoined with a periphery of a shell 24 of the LED bulb. The shell 24 has a distal end 18 connecting the light guider 14 and facing a light emitting side of the LED bulb, and the distal end 18 recesses backward to form a conical configuration with a reflecting surface 13 surrounding the light source 10 for converging light beams from the light source 10.

The heat dissipation section 2 includes a sleeve 20 at a rear of the optical section 1, and a sealed chamber 28 around the sleeve 20. The sleeve 20 is made of materials with excellent heat conductivity, and configured as a hollow tube with one sealed end 39. The sleeve 20 includes a tube portion 23 and a heat absorbing plate 21 arranged at the sealed end 39 thereof. An outer surface of the heat absorbing plate 21 is designated as the above mentioned heat absorbing surface 22 thermally contacting the substrate 12, thereby transferring heat of the light source 10 to the tube portion 23 via the heat absorbing plate 21. The chamber 28 is defined by an inner side surface of the shell 24 and an outer side surface of the sleeve 20, and represents an annular configuration surrounding the sleeve 20. The shell 24 is made of materials with excellent heat conductivity. A porous wick structure 29 is arranged on the outer sidewall of the tube portion 23 of the sleeve 20. In this embodiment, the wick structure 29 is made into a configuration of multiple stacked layers of metal meshes. In other exemplary embodiments, the wick structure 29 can also be made of sintered metal powders, a plurality of micro grooves, or combination thereof. The wick structure 29 contains working fluid 34 therein. It is to be said that, the chamber 28 is vacuumized to facilitate vaporization and condensation circulation of the working fluid 34 to obtain a better efficiency of heat dissipation.

The electrical section 3 includes the above mentioned threaded cap 32 away from the light source 10, and the circuit board 30 arranged in the sleeve 20. The circuit board 30 includes electrical components with different shapes and sizes which will generate heat during operation thereof for providing power supply, controlling circuit and power management for the light source 10. These electrical components can include, for example, rectifiers, resistors, capacitors, inductors, IC chip, and transformers, etc. A gap remained between the circuit board 30 and the sleeve 20 is filled with solidified electrically insulated encapsulation 31 which has excellent heat conductivity, whereby heat generated by the circuit board 30 can be transferred to the tube portion 23 of the sleeve 20 via the electrically insulated encapsulation 31. The shell 24 which defines the chamber 28 and the threaded cap 32 are interconnected by a tube like connecting piece 40. The connecting piece 40 includes a flange 41 radially protruding outward from a middle portion of an outer surface thereof, and two end portions extending oppositely along a central axis thereof. One end portion of the connecting piece 40 protrudes into the shell 24 to engage with an inner sidewall of the shell 24, with the flange 41 abutting against the shell 24. The other end portion of the connecting piece 40 protrudes into the threaded cap 32, with external threads 33 formed thereon and engaged with internal threads 33 of the threaded cap 32. The circuit board 30 is electrically connected to the electrodes 17 of the light source 10 by the wires 16, and electrically connected to the threaded cap 32 by the wires 16a. The threaded cap 32 is configured for being received in and engaged with a conventional light bulb socket (not illustrated). The threaded cap 32 is a standard screw connector such as an E26 or E27 base for an incandescent lamp.

When the light source 10 emits light upward, heat generated by the light source 10 is conducted to the tube portion 23 of the sleeve 20 via the heat absorbing plate 21, and heat generated by the circuit board 30 is conducted to the tube portion 23 too via the solidified encapsulation 31 inside the tube portion 23. The outer sidewall of the tube portion 23 is designated as an evaporation sector 48 equipped with the wick structure 29 thereon. The inner surface of the shell 24 with rather lower temperature forms a condensing sector 49. As such, the liquid state working fluid 34 in the wick structure 29 absorbs the heat in the tube portion 23 and vaporizes at a saturation temperature. The vaporized working fluid 34 with high enthalpy latent heat quickly expands and fills in the chamber 28 to occupy an annular vapor passage 47 with rather lower pressure and flow resistance. The vaporized working fluid 34 flows through the chamber 28 to the condensing sector 49, dissipates the latent heat through the shell 24 to a surrounding environment and is condensed to the liquid state working fluid 34 again at the saturating temperature. The condensed working fluid 34 in the condensing sector 49 falls into the bottom of the chamber 28 by gravity and is absorbed by the wick structure 29 by capillary force. In the falling process, the condensed working fluid 34 keeps dissipating sensible heat to the shell 24 and becomes a subcooled liquid state working fluid 34 with a fluid temperature lower than the saturation temperature. Successively, the subcooled liquid state working fluid 34 is absorbed into the wick structure 29 and through the wick structure 29 of the tube portion 23 to absorb the heat generated by the light source 10 and the circuit board 30 again, thereby to conduct more efficient circulation of the latent and sensible heat dissipation.

In the LED bulb of present embodiment, through the evaporation and condensation phase change process of the working fluid 34 inside the chamber 28, the heat can be effectively dissipated into the environment by a latent heat exchange mechanism. Because the heat transfer coefficient of the latent heat exchange mechanism is more than 100 to 1000 times higher than that of the pure liquid cooling. The mechanism can maintain in a low temperature with nearly a zero temperature gradient. Therefore, the LED bulb can be lighten and keep working in an uniform low temperature to ensure long-term high luminous efficiency, low light attenuation, stable and long lifespan.

In contrast, a traditional LED bulb usually attaches a light source thereof to a base of the heat sink, thereby dissipating heat generated by the light source to a plurality of fins the heat sink. Accordingly, the heat sink has a relatively long heat conduct path and needs a relatively high temperature gradient to drive the heat conduction. However, the desired high temperature gradient needs to be facilitated by a high temperature of the light source, thereby inevitably causing the light source overheated and disadvantageously keeping a high luminous efficiency, a low light attenuation, a stable and long lifespan of the traditional LED bulb.

For providing a high heat dissipating efficiency, the chamber 28 of the LED bulb is better vacuumized. Otherwise, the chamber 28 is filled with air which is a non-condensable gas with a high thermal resistance. As such, the air will obstruct the passage of vapor generation for vaporization and prevent vapor from contacting the shell 24 for condensation, thereby greatly decreasing heat dissipating efficiency thereof.

In most actual use, the LED bulb is a downlight luminaire. As such, a more favorable condition for heat dissipation is attributed to that the condensed liquid state working fluid 34 is more easily to reflow and collect to the converging conical surface 45 configured adjacent to the sleeve 20 and the light source 10, whereby the condensed working fluid 34 is capable of being absorbed by the wick structure 29 timely and transported by double actions of gravity and capillary force to facilitate an uniform and low operational temperature in the chamber 28.

In assembling of the LED bulb, the substrate 12 is fixed on the heat absorbing plate 21 with at least one bolt 15 at a predetermined position, and the circuit board 30 is fixed on a bottom sealing board 46 of the connecting piece 40. Then, the wick structure 29 is formed around an outer surface of the tube portion 23. Before putting the circuit board 30 into the tube portion 23, the wires 16 for connecting the substrate 12 and the wires 16a for connecting the threaded cap 32 are firstly soldered to the circuit board 30, and then the wires 16 are penetrated through holes predetermined in the heat absorbing plate 21 and the substrate 12 to electrically connect with the electrodes 17 of the substrate 12 and the wires 16a are penetrated through holes predetermined in the bottom sealing board 46. The circuit board 30 is arranged in to the tube portion 23 until a bottom end of the tube portion 23 abuts the bottom sealing board 46. The tube portion 23 is then filled up with an electrically insulating and heat conductive encapsulation 31 through holes in the bottom sealing board 46. The encapsulation 31 is solidified to make the light source 10, the circuit board 30 and the sleeve 20 with the wick structure 29 together as a whole to form a light engine. After that, the light engine is assembled to the shell 24 with the light source 10 facing the distal end 18 until the substrate 12 abuts an inner edge of an opening defined at the reflecting surface 13 of the shell 24 adjacent to the light guider 14. Therefore, the substrate 12 and the heat absorbing plate 21 are both engaging in the opening of the distal end 18 of the shell 24, a periphery of the connecting piece 40 is engaging in another opening defined in a bottom of the shell 24, and an end surface of the bottom of the shell 24 is abutting the flange 41 of the connecting piece 40. By sealing the joint of the end surface of the bottom of the shell 24 and the flange 41 of the connecting piece 40 forms the sealed chamber 28 with an annular receiving space between the sleeve 20 and the shell 24. The wires 16a are respectively penetrated a through hole 35 defined adjacent to the flange 41 and another through hole 35a defined at a center of a bottom of the threaded cap 32. After screwing the connecting piece 40 with external threads 33 into the threaded cap 32 with internal threads 33, the wires 16a are soldered to the threaded cap 32. Then the light guider 14 is assembled onto the distal end 18 of the shell 24. After the working fluid 34 is injected into the chamber 24, the chamber 28 is vacuumized and hermetically sealed.

Further, the wick structure 29 can be configured to extend over the heat absorbing surface 22 of the sleeve 20. As such, heat released by the light source 10 can be directly transferred to the working fluid 34 contained in or reflowed to the wick structure 29, thereby achieving a higher efficiency of heat dissipation.

Furthermore, the outer periphery of the shell 24 can be configured to extend various kinds of fins in the conventional art, particularly to a high power LED bulb with high heat dissipating requirement.

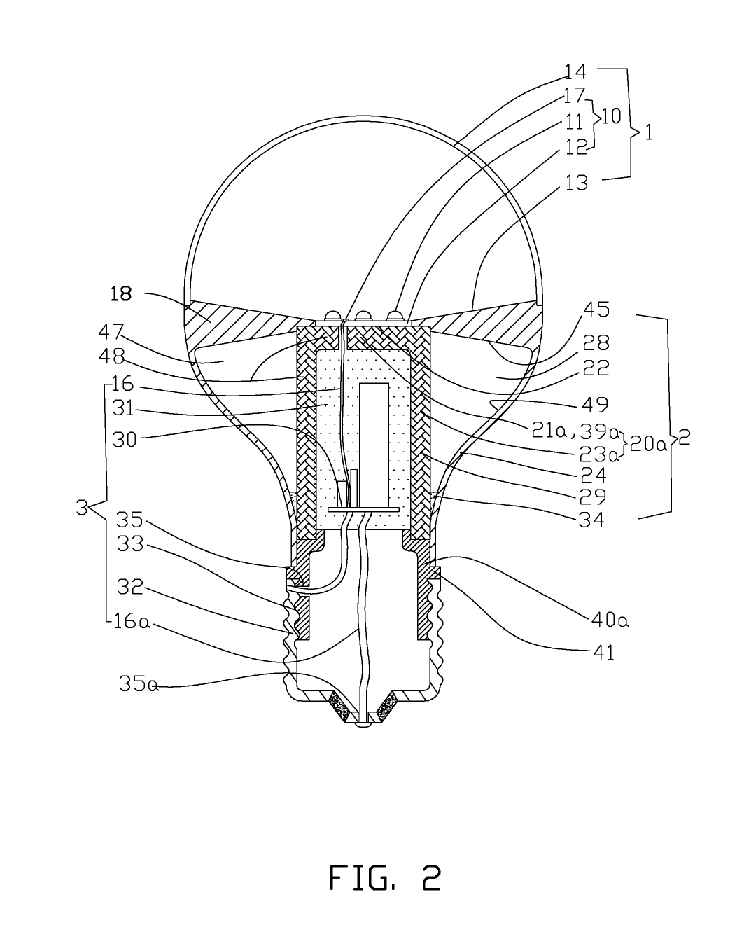

Referring to FIG. 2, an LED bulb in accordance with a second embodiment of present disclosure is provided. What is different from the LED bulb of the first embodiment is that, a sleeve 20a made of sintered powder with excellent heat conductivity is employed instead, and therefore the sleeve 20a is configured directly as a porous wick structure 29.

The sleeve 20a includes a tube portion 23a and a heat absorbing plate 21a arranged at the sealed end 39a thereof. An outer surface of the heat absorbing plate 21a is designated as the heat absorbing surface 22 thermally contacting the substrate 12, thereby absorbing heat released by the light source 10. The tube portion 23a absorbing heat released by the circuit board 30. The porous wick structure 29 contains liquid state working fluid 34 therein. The chamber 28 is vacuumized to achieve better heat dissipation effect. Besides, the bottom sealing board 46 of the connecting piece 40 of the first embodiment is omitted here to simplify the assembly of the LED bulb.

When the LED bulb of the second embodiment projects light upwardly through the light guider 14, heat generated by the light source 10 and the circuit board 30 will be transferred to the working fluid 34 contained in the porous wick structure 29 of the sleeve 20a, and the working fluid 34 will be heated and vaporized by the heat, thereby being immediately converted into saturated vapor and rapidly expanding to occupy the vapor passage 47. Then the condensing sector 49 will cool the saturated vapor in the chamber 28 and convert the saturated vapor back to liquid state working fluid 34 with subcooled temperature. Then the liquid state working fluid 34 will fall down under gravity along the tapering inner sidewall of the shell 24, and successively be absorbed by the porous wick structure 29. Thereafter, the liquid state working fluid 34 is drawn back into the wick structure 29 for absorbing heat generated by the light source 10 and the circuit board 30 again.

When the LED bulb of the second embodiment projects light downward, the working fluid 34 is more easily to reflow back for heat dissipation under double actions of gravity and capillary force of the porous wick structure 29.

As such, in contrast with the LED bulb of the first embodiment, the LED bulb of the second embodiment provides more powerful force to draw back the working fluid 34, and bigger vapor passage 47 for saturated vapor, thereby greatly facilitating heat dissipating efficiency thereof.

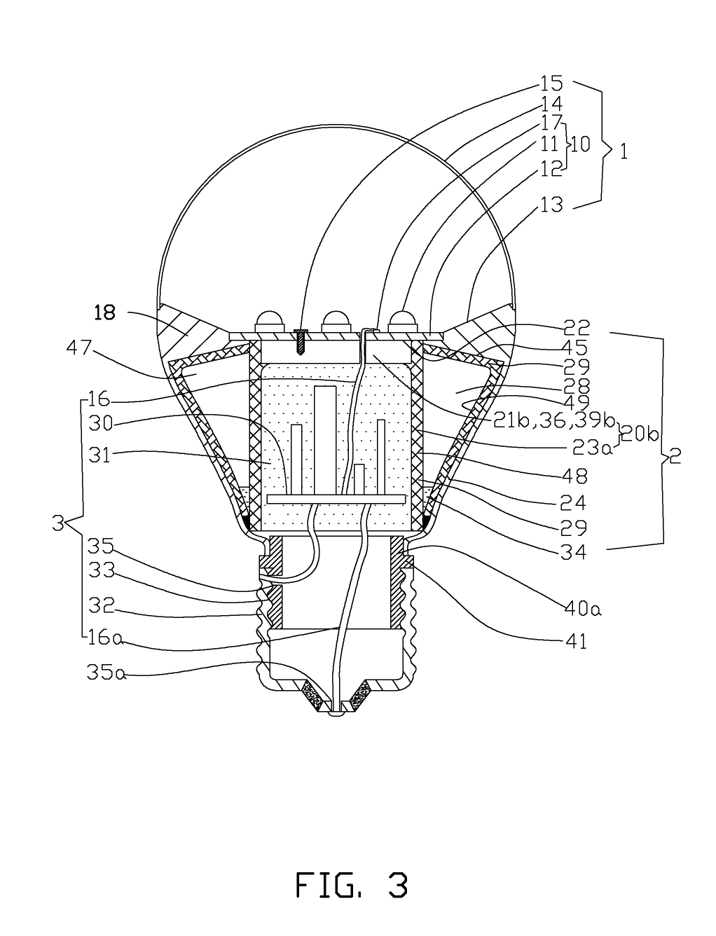

Referring to FIG. 3, an LED bulb in accordance with a third embodiment of present disclosure is provided. What is different from the LED bulb of the second embodiment is that, an inner surface of the shell 24 also has a wick structure 29 formed thereon. Therefore, more working fluid 34 can be contained in the chamber 28 for providing more efficient heat dissipation. In the third embodiment of the present disclosure, a sleeve 20b is employed instead of the sleeve 20a. The sleeve 20b includes a tube portion 23a and a heat spreading plate 36 arranged at a sealed end 39b thereof. The heat spreading plate 36 is made of high density and high heat conductive material, such as metal, and embedded into the sealed end 39b of the tube portion 23a, thereby sealing the sleeve 20b at one end. A surface of the heat spreading plate 36 facing an exterior of the sleeve 20 (i.e. adjacent to the light emitting side of the LED bulb) is designated as a heat absorbing surface 22, for transferring heat generated by the at least one LED 11 to the tube portion 23a. As such, the working fluid 34 contained in the wick structure 29 can be vaporized by the heat. Due to the shell 24 having a big size at a top end thereof, the sleeve 20b equipped with the light source 10 and the circuit board 30 is capable of being assembled into the shell 24 from the distal end 18 and the light source 10 can be configured with more LEDs without the necessity of increase volume thereof for accommodating the additional LEDs.

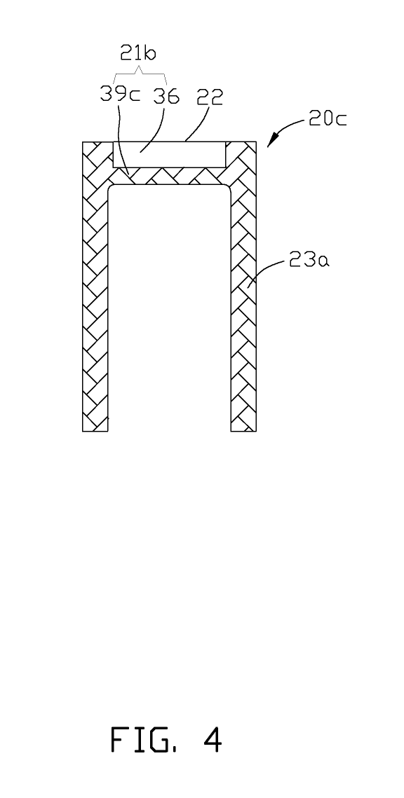

Referring to FIG. 4, another kind of sleeve 20c is provided with a tube portion 23a made of porous heat conductive material and a heat absorbing plate 21b. The heat absorbing plate 21b consists of a sealed end 39c of the tube portion 23a, and a heat spreading plate 36 embedded in the tube portion 23a and adjacent to the sealed end 39c. An outer surface of the heat spreading plate 36 is designated as the heat absorbing surface 22, thereby absorbing heat of the light source 10, spreading the heat, and transferring the heat uniformly to the sealed end 39c of the tube portion 23a. Successively, the heat will vaporize the working fluid 34 contained in the wick structure 29.

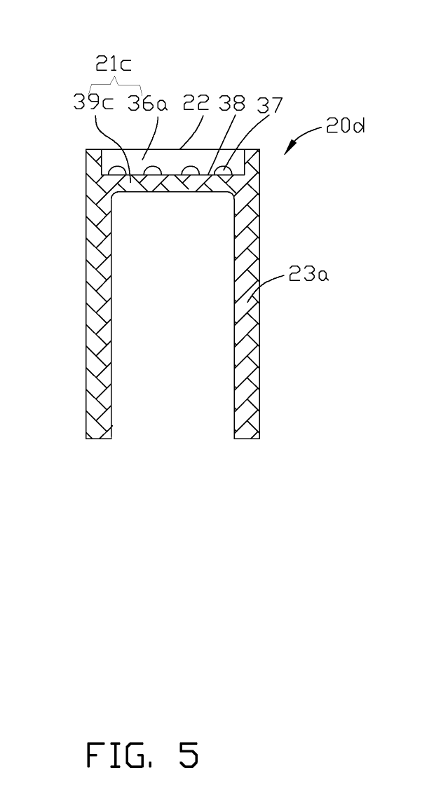

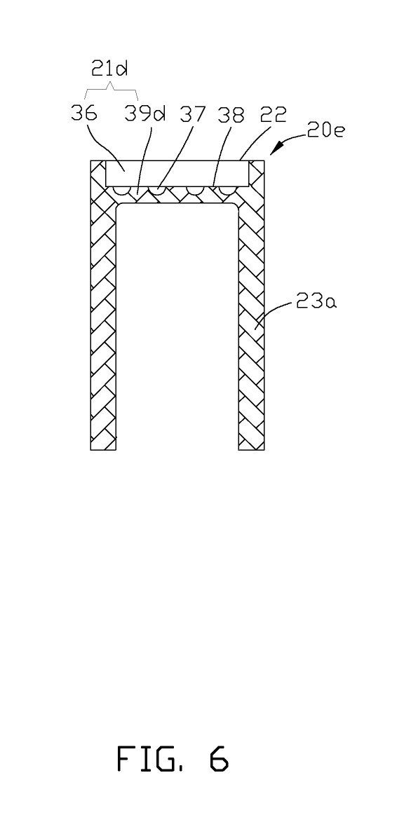

Referring to FIG. 5 and FIG. 6, in contrast with the sleeve 20c, the sleeves 20d and 20e further include a plurality of grooves 37 therein. Each groove 37 is located between the sealed end 39c (39d) and heat spreading plate 36a (36) and communicated with the chamber 28. In FIG. 5, the grooves 37 are defined in the spreading plate 36a. In FIG. 6, the grooves 37 are defined in the sealed end 39d. The vaporized working fluid 34 under rapid expansion can immediately flow through the plurality of grooves 37 under low flow resistance to reach the chamber 28, thereby achieving more efficient heat dissipation.

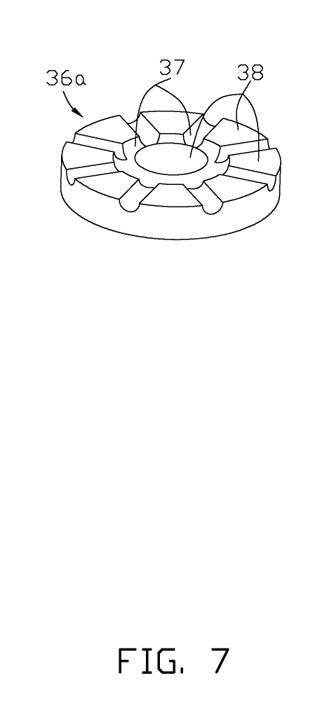

In FIG. 5, the plurality of grooves 37 is configured in a surface of the heat spreading plate 36a of the sleeve 20d. In FIG. 6, the plurality of grooves 37 is configured in a surface of the sealed end 39d of the sleeve 20e. The plurality of grooves 37 can also be configured inside the sealed end 39c, 39d. FIG. 7 illustrates an exemplary heat spreading plate 36a with a plurality of grooves 37. The heat spreading plate 36a includes an annular groove 37 formed at a center thereof, and a plurality of straight grooves 37 radially extending outward from the annular groove. The plurality of straight grooves 37 each communicate the annular groove 37 and extend to a periphery edge of the heat spreading plate 36a, thereby communicating the annular groove 37 with the chamber 28. A plurality of contacting surfaces 38 are configured, each between two neighboring straight grooves 37, thereby having the same numbers as that of the plurality of straight grooves 37. Another contacting surface 38 is surrounded by the annular groove 37. All the contacting surfaces 38 are configured for thermally contacting the substrate 12 and transferring heat from the light source 10 to the sealed end 39c, thereby heating and vaporizing the working fluid 34. Accordingly, heat generated by the light source 10 is transferred to the chamber 28 by distributary vapor passing through the grooves 37. The separated vapor paths can effectively mitigate the possible interferences between the expanded vapor and the liquid in the wick structure 29, thereby ensuring sufficient condensed liquid reflowed to the heat absorbing plate 21c (21d) for achieving more efficient heat dissipation.

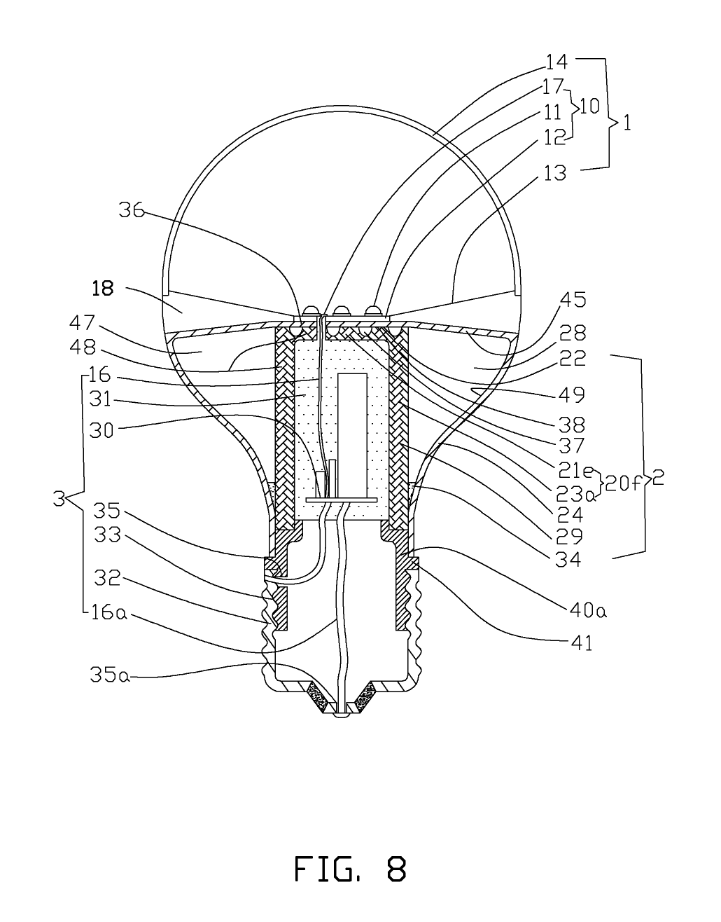

Referring to FIG. 8, an LED bulb in accordance with a fourth embodiment of the present disclosure is provided. What is different from the LED bulb of the former embodiments is that, the shell 24 of the fourth embodiment includes a plate sealing a top end thereof adjacent to the light emitting side of the LED bulb. The plate sealing the end functions as the heat spreading plate 36 to thermally contact both the substrate 12 and the heat absorbing plate 21e of the sleeve 20f, thereby achieving a heat dissipating function similar to that of the third embodiment.

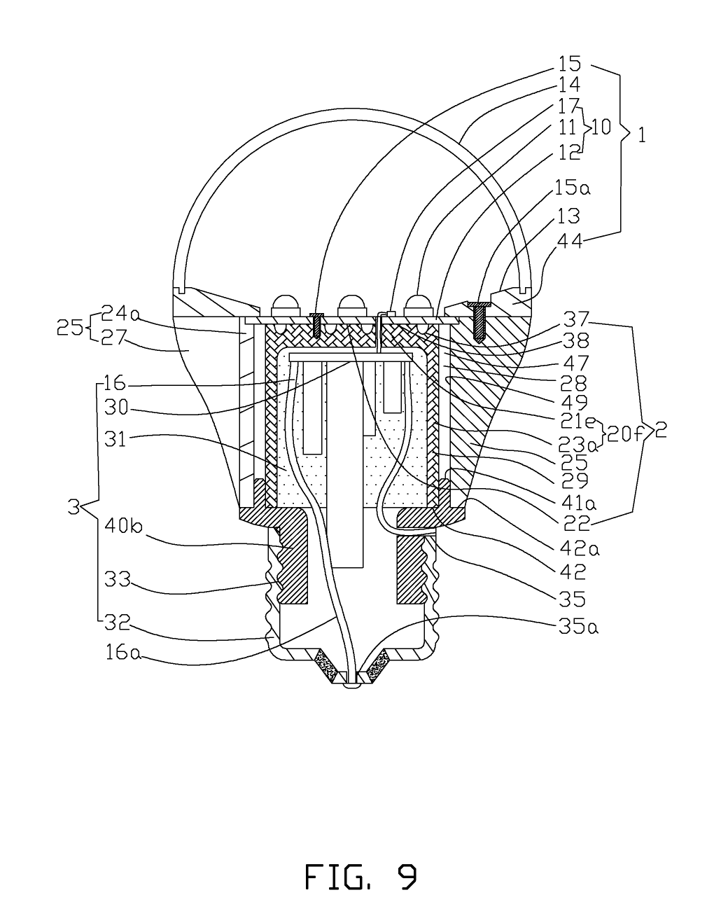

Referring the FIG. 9, an LED bulb in accordance with a fifth embodiment of present disclosure is provided. What is different from the LED bulb of the third embodiment is that, the LED bulb of the fifth embodiment employs an extruded heat sink 25 to replace the shell 24. The heat sink 25 is made of materials with excellent heat conductivity. The heat sink 25 includes a hollow tube-like shell 24a, and a plurality of fins 27 radially extending outward from the shell 24a. A sleeve 20f the same as that of the fourth embodiment is employed in the fifth embodiment. An inner sidewall of the shell 24a is spaced from the outer sidewall of the tube portion 23a of the sleeve 20f, thereby cooperatively forming an annular and sealed chamber 28. The plurality of fins 27 each has a length along a radial direction of the shell 24a, tapering from the top end of the shell 24a to the bottom end of the shell 24a. When assembled, the substrate 12 of the light source 10 is fixed on the heat absorbing plate 21e of the sleeve 20f by bolts 15, and then the light source 10 and the sleeve 20f are inserted into the shell 24a together. Successively, a peripheral edge of the substrate 12 beyond the heat absorbing plate 21e is applied with glue and adhered to the shell 24a at the opening of the shell 24a, to seal the chamber 28 and ensure the sleeve 20f coaxial with the shell 24a. Then, an annular cover 44 is attached on a top end surface of the fins 27 adjacent to the optical section 1. The cover 44 defines a conical reflecting surface 13 gradually enlarging along a direction away from the LEDs 11 of the LED bulb. The annular cover 44 is fixed on the fins 27 by bolts 15a, with an inner edge abutting the periphery edge of the substrate 12, thereby surrounding the LEDs 11 of the light source 10. Finally, the heat sink 25 is connected with the threaded cap 32 via a connecting piece 40b made of electrical insulated material. The connecting piece 40b has a tube like configuration with a flange 41a axially protruding upward from a top end thereof. A step portion 42 is defined at an inner side of the flange 41a, and a step portion 42a is defined at an outer side of the flange 41a. The flange 41a is applied with glue and then inserted into the chamber 28, whereby the flange 41a is adhered to an inside of the shell 24a and an outside of the sleeve 20f. In this condition, the step portion 42 abuts a bottom end of the sleeve 20f, and the step portion 42a abuts a bottom end of the shell 24a. A bottom end of the connecting piece 40b further includes outer thread 33 configured on an outer sidewall thereof, for engaging with an inner thread 33 of the threaded cap 32.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An LED bulb, comprising:
an optical section arranged at a top portion of the LED bulb, the optical section having a light source and a light guider, the light source further comprising a substrate, both the at least one LED and a plurality of electrodes are mounted on and electrically connected to an electrical circuit formed on one side of a heat conductive plate of the substrate;
a heat dissipation section arranged at a middle portion of the LED bulb, the heat dissipation section having a sleeve at a rear of the optical section and a chamber, the sleeve comprising a tube portion with a sealed end, the sealed end comprising a heat absorbing surface thermally contacting the other side of the heat conductive plate of the substrate opposite to the at least one LED, the chamber having a hermetically sealed annular configuration and being defined between an inner side surface of an LED bulb shell and an outer side surface of the sleeve; and
an electrical section with a threaded cap arranged at a bottom portion of the LED bulb, and a circuit board received in the sleeve for providing power supply, controlling circuit and power management for the light source, the plurality of electrodes of the light source being electrically connected to the circuit board by one pair of wires, and the circuit board being electrically connected to the threaded cap of the electrical section by another pair of wires;
wherein a porous wick structure is arranged on an outer sidewall of the tube portion of the sleeve and contains working fluid therein, heat generated by the at least one LED and the circuit board cause the working fluid to become vapor flowing into the chamber, and condensed liquid flowing back to the wick structure, thereby conducting circulation of latent and sensible heat dissipation.

2. The LED bulb of claim 1, wherein the tube portion of the sleeve is made of sintered powder, with a porous configuration designated as a wick structure.

3. The LED bulb of claim 2, wherein the inner side surface of the LED bulb shell has a wick structure arranged thereon.

4. The LED bulb of claim 3, wherein the wick structure is multiple stacked layers of metal meshes, sintered metal powders, a plurality of micro grooves, or combination thereof.

5. The LED bulb of claim 1, wherein the sleeve is made of sintered powder, with a porous configuration designated as a wick structure.

6. The LED bulb of claim 5, wherein a plurality of grooves is formed at the sealed end of the sleeve and communicated to the chamber.

7. The LED bulb of claim 6, wherein the plurality of grooves is formed in the heat absorbing surface of the sealed end.

8. The LED bulb of claim 5, wherein a heat spreading plate is embedded in the tube portion of the sleeve adjacent to the sealed end thereof, a plurality of grooves is defined in a contacting surface between the heat spreading plate and the sealed end.

9. The LED bulb of claim 8, wherein the plurality of grooves comprise an annular groove around a center of the contacting surface, and a plurality of straight grooves radially extending from the annular groove and communicated with the chamber.

10. The LED bulb of claim 5, wherein a heat spreading plate is embedded in the tube portion of the sleeve to form the sealed end, and an outer surface of the heat spreading plate acts as the heat absorbing surface.

11. The LED bulb of claim 8, wherein the heat spreading plate further comprises a plurality of grooves communicated to the chamber, the plurality of grooves being formed in a surface of the heat spreading plate adjacent to the sealed end of the tube portion of the sleeve.

12. The LED bulb of claim 1, wherein the LED bulb shell comprises a heat spreading plate adjacent to a light emitting side thereof, the heat spreading plate sealing an end of the LED bulb shell, the heat spreading plate thermally contacting the substrate and the heat absorbing surface of the sleeve.

13. The LED bulb of claim 1, wherein the LED bulb shell comprises a plurality of fins radially extending outward therefrom, an annular cover is fixed on a top end surface of the fins by bolts and adjacent to the optical section, the annular cover defines a gradually enlarging conical reflecting surface facing a light emitting side of the LED bulb, and a central hole of the annular cover has an inner edge abutting the periphery edge of the substrate and surrounding the at least one LED of the light source.

14. The LED bulb of claim 13, wherein the plurality of fins each has a length along a radial direction of the LED bulb shell tapering from the top end of the LED bulb shell to the bottom end of the LED bulb shell.

15. The LED bulb of claim 1, wherein the threaded cap connects with the LED bulb shell by a connecting piece.

16. The LED bulb of claim 15, wherein the connecting piece has a tube-shaped configuration with a flange axially protruding upward from a top end thereof, a first step portion being defined at an inner side of the flange, a second step portion being defined at an outer side of the flange, the flange being engaged in the chamber with the first step portion abutting a bottom end of the sleeve, and the second step portion abutting a bottom end of the LED bulb shell, a bottom end of the connecting piece having outer thread configured on an outer sidewall thereof and engaged with an inner thread of the threaded cap.

17. The LED bulb of claim 15, wherein the connecting piece is tube-shaped, the connecting piece comprising a flange radially protruding outward from a middle portion thereof, one end portion of the connecting piece protruding into the LED bulb shell to engage with an inner sidewall of the LED bulb shell, with the flange abutting against the LED bulb shell, the other end portion of the connecting piece protruding into the threaded cap, the other end having an outer thread formed thereon and engaged with an inner thread of the threaded cap.

18. The LED bulb of claim 1, wherein the LED bulb shell further comprises a distal end connecting the light guider, the distal end recessing backward to form a conical configuration tapering towards the heat absorbing plate.

19. The LED bulb of claim 1, wherein the optical section further comprises a conical reflecting surface gradually enlarging along a direction away from the at least one LED of the LED bulb.

20. The LED bulb of claim 1, wherein a circuit board is received in the sleeve and spaced from the sleeve, a gap remained between the circuit board and the sleeve being filled with solidified electrically insulating and thermal conductive encapsulation.

21. The LED bulb of claim 1, wherein the chamber is vacuumized.
